(19) United States
(12) Patent Application Publication
(10) Pub. No.: US 2023/0019642 A1
(43) Pub. Date: Jan. 19, 2023

(54) SYSTEM AND A CONTROL METHOD THEREOF

(71) Applicant: CANON KABUSHIKI KAISHA, Tokyo (JP)

(72) Inventor: Junji Sato, Kanagawa (JP)

(21) Appl. No.: 17/862,746

(22) Filed: Jul. 12, 2022

(30) Foreign Application Priority Data
Jul. 13, 2021 (JP) 2021-115962

(51) Int. Cl. H04N 1/44; H04N 1/00

(52) U.S. Cl. CPC H04N 1/4433; H04N 1/00344

(57) ABSTRACT

A system is configured to include a device provided with a SIM and a device management server, wherein the SIM and a contract are managed in association with each other, and when the SIM is mounted on a device, second identification information that identifies the device is associated with the SIM and is transmitted to the device management server, and in a case in which the second identification information associated with the SIM has changed, the second identification information is registered in the contract when the device is determined to have a contract that is identical to the contract. The determination of whether or not a device has a contract that is identical to the contract is performed based on the position information of the SIM.

This application claims the benefit of Japanese Patent Application No. 2021-115962, filed Jul. 13, 2021, which is hereby incorporated by reference wherein in its entirety.

### BACKGROUND OF THE INVENTION

### Field of the Invention

The present invention relates to a system that includes an image processing device and a management system, and a system control method.

### Description of the Related Art

In conjunction with the spread of cloud services and IoT (Internet of Things), systems that manage devices such as image processing devices with a device management server are becoming known. In implementing IoT, a configuration in which a device communicates directly with a cloud service by means of a communication device such as a SIM (Subscriber Identity Module) card is common. That is, a vendor of an IoT device makes a SIM card contract with a communication provider, and provides an IoT service to a user of the device by mounting the SIM card on the IoT device. The user of the IoT device makes a user contract for an IoT service, and uses the purchased IoT device by registering the purchased IoT device in the cloud. Thereby, the user will be able to use a variety of IoT services, such as checking the usage status of the IoT device online.

Because an IoT device can replace a communication device, appropriate management is required to ensure that the IoT device and the communication device are appropriately used and the like. Japanese Patent Application Laid-open No. 2016-117255 discloses a configuration in which the position information of a communication device is used as a method to appropriately manage the relocation of a device. If the position information of the communication device is changed when the communication device used by the device is changed, the device stops its own function, and is thereby able to prevent unauthorized relocation of the device.

However, in a case in which an IoT device is to be replaced with a new IoT device, in the technology disclosed in JP 2016-117255, it is necessary to swap the SIM card from the old device to the new device, and further register the new device in a cloud service. This is particularly cumbersome in the case of an inexpensive IoT device in which a user, instead of a service person, installs the new IoT device themselves.

### SUMMARY OF THE INVENTION

The present invention has been made in view of the above described circumstances, and provides a system to reduce the workload of registering a new device to a cloud service in a case in which a SIM card is replaced in a different IoT device and used.

In order to achieve the above described object, a system according to the present invention is configured to include an image processing device configured to include a module that holds a first identification information that can identify a subscriber who has made a contract for a specific mobile communication, and a management system, the system comprising: a memory storing instructions; anda processor executing the instructions causing the system to: manage the module and the contract in association with each other; associate a second identification information that identifies the image processing device with the module in a state that the module is mounted on the image processing device, and transmit the second identification information to the management system; and register, in a case in which a second identification information associated with the module has changed, the second identification information in the contract when it is determined that the image processing device has a contract that is identical to the contract, wherein the determination as to whether or not the image processing device has a contract that is identical to the contract is performed based on the position information of the module.

Further features of the present invention will become apparent from the following description of exemplary embodiments (with reference to the attached drawings).

### BRIEF DESCRIPTION OF THE DRAWINGS

FIG. 1 is a diagram showing an example of a system configuration.

FIG. 2 is a diagram showing an example of a hardware configuration of a device and a device management server.

FIG. 3 is an explanatory diagram showing an example of a software configuration of a device and a device management server.

FIG. 4 is a table showing an example of contract information.

FIG. 5 is a table showing an example of SIM information.

FIG. 6 is a table showing an example of device information.

FIG. 7 is a flowchart showing an example of identification information notification processing of a device.

FIG. 8 is a flowchart showing an example of identification information reception processing of a device management server.

FIG. 9 is a table showing an example of SIM information.

FIG. 10 is a table showing an example of device information.

FIG. 11 is a table showing an example of device information according to the second embodiment.

FIG. 12 is a flowchart showing an example of identification information reception processing of a device management server according to the second embodiment.

### DESCRIPTION OF THE EMBODIMENTS

Hereinafter, embodiments for implementing the present invention will be explained with reference to the drawings. Note that the following embodiments do not limit the present invention according to the scope of the claims, and not all combinations of features explained in the present embodiment are essential in the means for solving the problem of the present invention and redundant explanations thereof are omitted. Note that identical configuration elements are denoted by identical reference signs in the description.

### First Embodiment

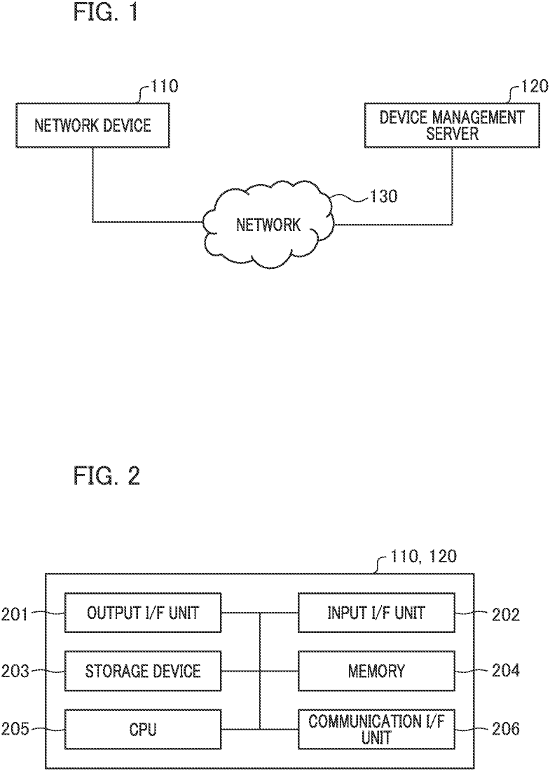

FIG. 1 is a diagram showing an example of a system configuration. As shown in FIG. 1, the system of the present embodiment includes a network device 110 (hereinafter abbreviated as “device 110”), a device management server 120, and a network 130. The device 110 is connected to the device management server 120 via a network 130 such as the Internet. Thus, the system according to the present embodiment includes the device 110 serving as an image processing device and the device management server 120 serving as a management system.

The device 110 is an information processing device that is installed in a customer organization and used, and may include, for example, an image processing device such as a printer, a copying machine, a scanner, or the like. A customer organization refers to an organization such as a company that actually uses the device 110, and the information that relates to the device is managed for each customer organization in the device management server 120.

Note that although only one device 110 is shown in FIG. 1, a plurality of devices 110 may exist in one customer organization. Further, devices 110 of a plurality of customer organizations may be connected to one device management server 120.

A server connection application (not shown) is installed in the device 110. The device 110 transmits setting information, operation information, and the like to the device management server 120 by using a server connection application.

FIG. 2 is a diagram showing an example of a hardware configuration of a device and a device management server. In the server computer, an output I/F unit 201 is connected to an output device such as a display. An input I/F unit 202 is connected to an input device such as a keyboard.

A storage device 203 stores the setting information, operation information, and the like. The setting information and operating information are received from an authentication program and a management program in the OS (Operating System) and the device management server 120 of the registration information device 110 and device 110. In this context, an authentication program is a program that performs authentication/connection processing. In addition, a management program is a program for managing the registered device 110.

The CPU 205 loads the authentication program and the management program from the storage device 203 into a memory 204, and executes the authentication program and the management program. The communication I/F unit 206 is a network interface, such as a SIM card, for controlling communication of the device 110 via the network 130.

Note that the diagram showing the hardware configuration shown in FIG. 2 corresponds to a hardware block diagram of a general information processing device, and is also applied to the device 110 of the present embodiment. Therefore, because the hardware configuration of the device 110 is also similar, the description thereof will be omitted.

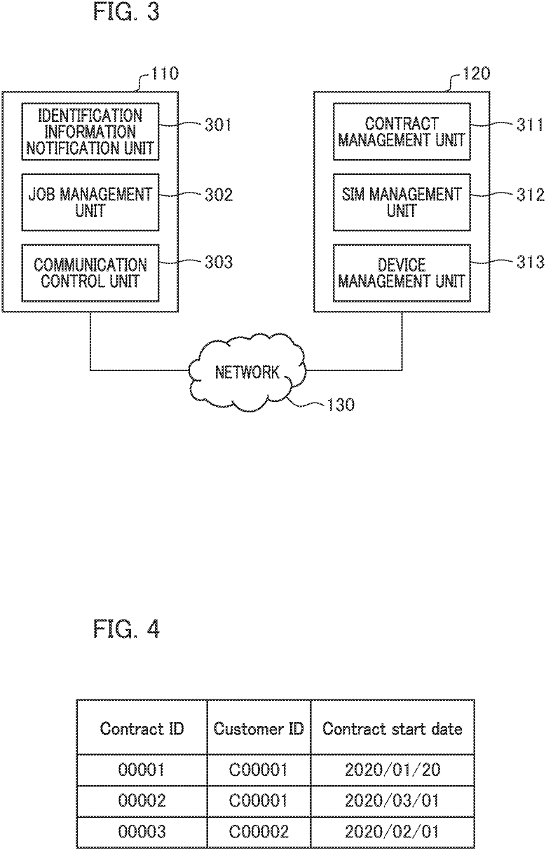

FIG. 3 is an explanatory diagram showing an example of a software configuration of a device and a device management server. The device 110 includes an identification information notification unit 301, a job management unit 302, and a communication control unit 303. The identification information notification unit 301 notifies the device management server 120 of the identifiers of the device 110 and the communication I/F unit 206. The job management unit 302 determines whether or not a job can be executed on the device and performs job execution management. The communication control unit 303 performs communication with the outside via the communication I/F unit 206.

Here, a “job” refers to a processing performed by the device 110. The processing executed by the device 110 is performed by receiving a user operation via the input I/F unit 202, and according to various programs stored in the storage device 203 and the memory 204 and an execution schedule thereof. For example, a print process, a scan process, or a process to send counter information to the device management server 120 and the like correspond to a “job”.

The device management server 120 includes a contract management unit 311, a SIM management unit 312, and a device management unit 313. The contract management unit 311 manages contract information for a user to use the device 110. The SIM management unit 312 manages the information of the communication I/F unit 206 of the device 110, specifically, the identification information of the SIM in the present embodiment, in association with a contract. In the present embodiment, a SIM is exemplified and specifically explained as the communication I/F unit 206 of the device 110. The device management unit 313 manages information of the device 110 registered in the device management server 120. Thereby, in the present embodiment, the SIM is an example of a module that holds a SIM ID that can identify a subscriber who has made a contract for a specific mobile communication.

FIG. 4 is a table showing an example of contract information. FIG. 4 shows an example of contract information managed by the contract management unit 311. A “contract ID” is an identifier for the unique specification of a contract. A “customer ID” is an identifier for the unique specification of a customer who has made a contract. In this context, a customer is a subscriber who is a user of the device and who has made a contract for a specific mobile communication. A single customer may enter into a plurality of contracts. A “contract start date” is the date on which a contract is started. Thus, in the present embodiment, the contract management unit 311 is an example of a management unit that manages a SIM and a contract in association with each other.

Management of the contract information of FIG. 4 is performed by accessing the device management server 120 from an information terminal such as a PC (not shown) using a Web browser or the like when the service provider enters into a service use contract with the user of the device 110. Note that the service provider is generally identical to the provider of the device 110.

FIG. 5 is a table showing an example of SIM information. FIG. 5 shows an example of SIM information managed by the SIM management unit 312. Specifically, the service setting ID=S001 in FIG. 4 is an example of a service setting.

In FIG. 5, a “SIM ID” is an identifier (first identification information) for uniquely identifying a SIM mounted on the device 110. A “Contract ID” is an identifier for uniquely identifying a contract information using the corresponding SIM. In this context, the contract information is the information managed by the contract management unit 311 in FIG. 4. A “Status” is the utilization state of the SIM. The status changes by making the SIM available or stopping the use thereof. The availability of the SIM is performed by a service provider (that is, a device provider) performing a predetermined procedure with a communication provider, which is the provider of the SIM, based on the state of the service use contract of the user.

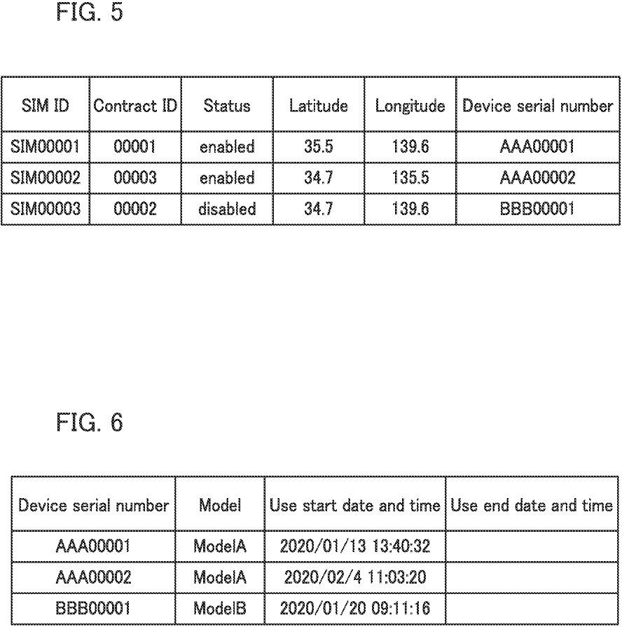

A “latitude” and a “longitude” are the position information of the SIM. Specifically, the latitude and the longitude are obtained by using a known technique such as positioning based on a base station information used when the SIM communicates, and are updated and recorded at a predetermined timing, such as at the time of communication with the device 110. A “Device Serial Number” is an identifier (second identification information) for uniquely identifying device information. The device information is managed by the device management unit 313 (refer to FIG. 6).

FIG. 6 is a table showing an example of device information. In FIG. 6, an example of device information managed by the device management unit 313 is shown.

In FIG. 6, a “Device Serial Number” is an identifier for uniquely identifying the device 110. The “Model” is the model information of the device 110. The “Use Start Date and Time” is the date and time when the device 110 was registered in the device management server 120. The “Use End Date and Time” is the date and time when the customer ends the use of the device 110 under the contract, and is left blank until the use is ended.

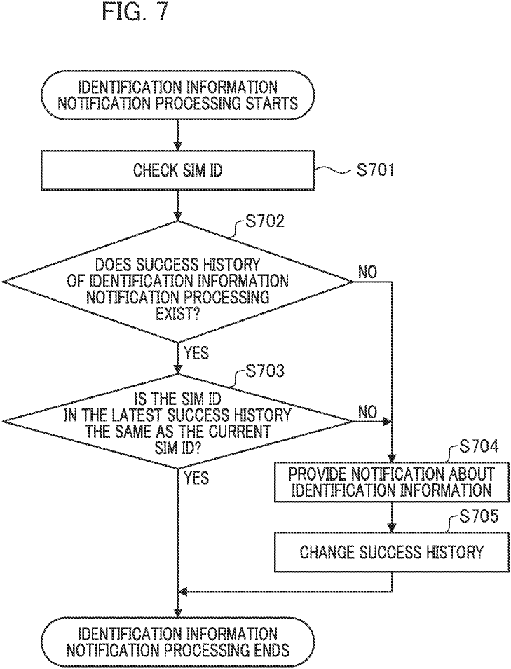

FIG. 7 is a flowchart showing an example of identification information notification processing of the device 110. In FIG. 7, an example of a processing in which the identification information notification unit 301 of the device 110 notifies the device management server 120 about the identification information is shown. This processing is executed at a predetermined timing, such as when the device 110 is started. The CPU 205 executes processing based on a program stored in the storage device 203 or the memory 204, thereby realizing the processing of the flowchart.

In step S701, the identification information notification unit 301 obtains an identifier of the communication I/F unit 206 mounted on the SIM ID, that is, the device 110, via the communication control unit 303. Thereby, in the present embodiment, the identification information notification unit 301 is an example of a transmission unit that transmits the device serial number to the device management server 120 in association with the SIM in a state that the SIM is mounted on the device 110.

In step S702, the identification information notification unit 301 checks whether the success history of the identification information notification processing is recorded in the device 110. In a case in which the success history of the identification information notification process exists, the processing proceeds to step S703, and in a case in which the success history does not exist, the processing proceeds to step S704.

In step S703, the identification information notification unit 301 checks whether the SIM ID recorded in the latest recorded success history and the current SIM ID checked in step S701 are identical. In a case in which the SIM IDs are identical, the identification information notification processing ends, and in a case in which the SIM IDs are not identical, the processing proceeds to step S704.

In step S704, the identification information notification unit 301 notifies the device management server 120 about the SIM ID obtained in step S701 and the serial number of the device 110.

In step S705, the identification information notification unit 301 records the information for which notification is provided to the device management server 120 in step S704 as a success history in the storage device 203.

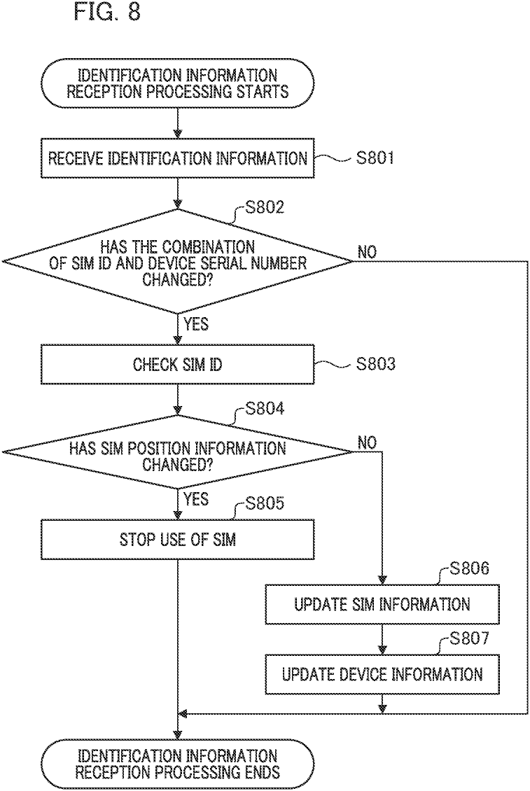

FIG. 8 is a flowchart showing an example of identification information reception processing of the device management server 120. In FIG. 8, an example of a processing when the device management server 120 receives the identification information is shown. The processing of the flowchart is realized by the CPU 205 executing the processing based on a program stored in the storage device 203 or the memory 204.

In step S801, the SIM management unit 312 receives the identification information from the device 110. The identification information is transmitted in step S704, and includes a SIM ID and a device serial number.

In step S802, the SIM management unit 312 checks whether the combination of the SIM ID and device serial number received in step S801 is changed in comparison with the SIM information managed by the SIM management unit 312. In a case in which the combination of the SIM ID and the device serial number is changed, the processing proceeds to step S803, and in a case in which the combination of the SIM ID and the device serial number is not changed, the identification information reception processing ends. Thereby, in the present embodiment, in a case in which the device serial number of the device 110 associated with the SIM is changed, the SIM management unit 312 has a function which determines whether or not the device 110 has a contract that is identical to the contract. That is, when a SIM has been replaced in a new device 110, the SIM management unit 312 determines whether or not the device 110 on which the SIM is newly mounted is within the initial contract range.

In step S803, the SIM management unit 312 obtains the current position information of the SIM.

In step S804, the SIM management unit 312 checks whether the position information of the SIM obtained in step S803 has changed in comparison with the SIM information managed by the SIM management unit 312. More specifically, it is checked whether the amount of change in position information exceeds a predetermined threshold. In a case in which the position information of the SIM has changed, the processing proceeds to step S805, and in a case in which the position information of the SIM has not changed, the processing proceeds to step S806. Thereby, the determination as to whether or not the device 110 on which the SIM is newly mounted has a contract that is identical to the contract is performed based on the positional information of the SIM.

In step S805, the SIM management unit 312 determines that the corresponding SIM has been diverted to a new device 110 associated with a contract different from that of the previous device 110, and stops the use of the SIM. Specifically, in the example of FIG. 5, the status of the corresponding SIM is changed to “disabled”, and a use stop instruction of the SIM is transmitted to a system (not shown) of the communication provider providing the SIM. Thereby, in the present embodiment, in a case in which the SIM management unit 312 determines that the new device 110 has a contract that is identical to the contract, the SIM management unit 312 makes the device 110 available for use. In contrast, in a case in which the SIM management unit 312 determines that the new device 110 is not of a contract that is identical to the contract, the SIM management unit 312 makes the device 110 unavailable for use.

In step S806, the SIM management unit 312 determines that the corresponding SIM has been diverted to a new device 110 associated with an identical contract as that of the previous device 110, and updates the device serial number of the corresponding SIM among the SIM information of FIG. 5.

In step S807, the SIM management unit 312 adds the device serial number received in step S801 to the device information of FIG. 6 via the device management unit 313. Thereby, in the present embodiment, the SIM management unit 312 is an example of a registration unit that registers the device serial number in the contract when the device serial number is determined to be of a contract that is identical to the contract.

Note that in the example of FIG. 8, the use of the SIM is stopped at step S805, but the present embodiment is not limited thereto, and the manual registration of the device 110 may be promoted. For example, in step S805, a response indicating that a device registration is required is transmitted to the device 110, and a device registration screen (not shown) is displayed in the device 110. Thereby, a configuration can be conceived in which a user is prompted to input device registration information.

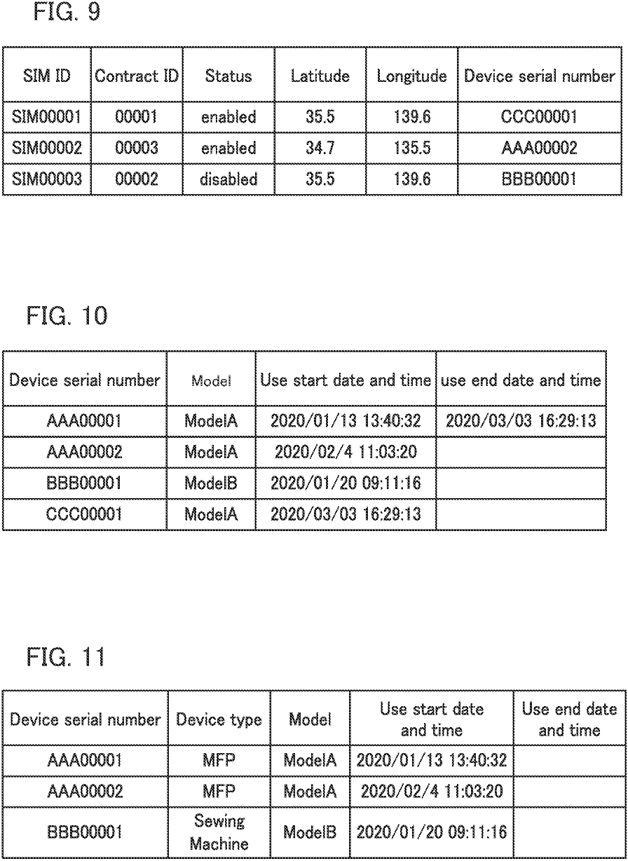

FIG. 9 is a table showing an example of SIM information. FIG. 9 shows an example of the SIM information updated in step S806, and the SIM information shown in FIG. 5 is updated. The difference from FIG. 5 is the point that the device serial number associated with the SIM of SIM ID = SIM00001 has been updated from AAA00001 to CCC00001.

FIG. 10 is a table showing an example of device information. FIG. 10 shows an example of the device information updated in step S807, and the device information shown in FIG. 6 is updated. The difference from FIG. 6 is the point that the device information of device serial number = CCC00001 has been added, and the use end date and time of device serial number = AAA00001 has been set.

That is, FIG. 9 and FIG. 10 show that the SIM used in the device 110 of the device serial number AAA00001 is replaced in the device 110 of the device serial number CCC00001.

According to the first embodiment explained above, when the SIM card is replaced in a new IoT device, the position information of the device is verified, and the device information of the device management server is automatically updated. Thereby, it is possible to reduce the device registration workload associated with the replacement of an IoT device in an identical contract.

### Second Embodiment

In the second embodiment, the configurations shown in FIGS. 1 through 5, 7, and 9 are identical as that of the first embodiment. Therefore, identical reference numerals are used for portions similar to those of the first embodiment, and the description thereof is omitted. Hereinafter, points of difference from the first embodiment will be mainly explained.

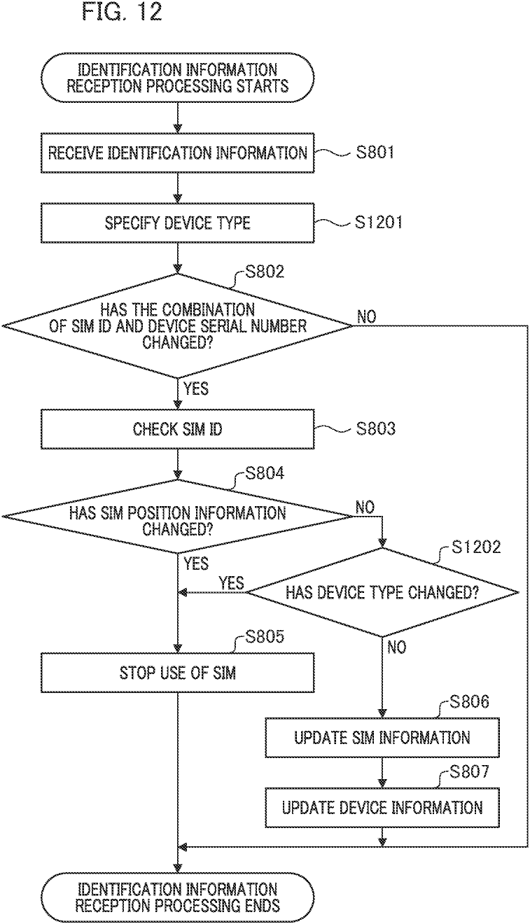

FIG. 11 is a table showing an example of device information according to the second embodiment. FIG. 11 shows an example of device information managed by the device management unit 313, and is an example corresponding to FIG. 6 of the first embodiment. The difference from FIG. 6 is the point that the device type is held for each device.

FIG. 12 is a flowchart showing an example of identification information reception processing of the device management server 120 according to the second embodiment. FIG. 12 shows an example of processing when the device management server 120 receives identification information. The difference from FIG. 8 according to the first embodiment is the point that the processing of steps S1201 and S1202 is added. Identical processing as that of FIG. 8 uses identical reference numerals, and descriptions thereof will be omitted. The processing of the flowchart is realized by the CPU 205 executing processing based on a program stored in the storage device 203 or the memory 204.

In step S1201, the SIM management unit 312 specifies the device type of the device 110 that has transmitted the identification information based on the device serial number received in step S801 via the device management unit 313.

In step S1202, the SIM management unit 312 checks whether the device type identified in step S1201 is changed. Specifically, the device serial number corresponding to the SIM ID received in step S801 is specified based on the SIM information shown in FIG. 5, and the device type of the device serial number is obtained via the device management unit 313 to perform the check. In a case in which the device type is changed, the processing proceeds to step S805, and if it is not changed, the processing proceeds to step S806.

According to the second embodiment described above, in a case in which the SIM card is replaced in a new IoT device, the type of the device is verified in addition to the positional information of the device, and the device information of the device management server is automatically updated. Thereby, it is possible to accurately perform device registration work associated with the replacement of an IoT device in an identical contract, and to reduce the device registration workload.

Note that although in the present embodiment, whether a contract is an identical contract is determined by verifying the type of device, it may be determined based on other information. For example, when an error occurs in the device 110, error information (not shown) to be notified to the device management server 120 is recorded in the device management unit 313. In addition, in a case in which a critical error occurs in the device before the SIM card is replaced at the timing of step S1202, it is determined that the device 110 is being replaced due to a failure, the processing proceeds to step S806, and the device registration processing may be performed automatically.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A system which includes an image processing device configured to include a module that holds a first identification information that can identify a subscriber who has made a contract for a specific mobile communication, and a management system, the system comprising:
a memory storing instructions; and
a processor executing the instructions causing the system to:
manage the module and the contract in association with each other;
associate a second identification information that identifies the image processing device with the module in a state that the module is mounted on the image processing device, and transmit the second identification information to the management system; and
register, in a case in which a second identification information associated with the module has changed, the second identification information in the contract when it is determined that the image processing device has a contract that is identical to the contract,
wherein the determination as to whether or not the image processing device has a contract that is identical to the contract is performed based on the position information of the module.

2. The system according to claim 1,
wherein the processor determines that the image processing device has a contract that is identical to the contract in a case in which the position information of the module is not changed.

3. The system according to claim 1,
wherein the processor determines that the image processing device has a contract that is identical to the contract in a case in which the position information of the module is not changed, and the type of the image processing device is not changed.

4. The system according to claim 1,
wherein the processor makes the image processing device usable in a case in which it is determined that the image processing device has a contract that is identical to the contract.

5. A method for controlling a system that is configured to include an image processing device provided with a module that holds a first identification information that can identify a subscriber who has made a contract for a specific mobile communication, and a management system, the method comprising:
associating and managing the module and the contract;
transmitting, in a state that the module is mounted on the image processing device, a second identification information that identifies the image processing device to the management system by associating the second identification information with the module; and
registering, in a case in which the second identification information associated with the module has changed, the second identification information in the contract when it is determined that the image processing device of the module has a contract that is identical to the contract,
wherein the determination of whether or not the image processing device is has a contract that is identical to the contract is performed based on the position information of the module.
